(19) United States
(12) Patent Application Publication
(10) Pub. No.: US 2006/0149414 A1
(43) Pub. Date: Jul. 6, 2006

(54) Remote web access control of multiple home comfort systems

(75) Inventors: Raymond J. Archacki JR., Wethersfield, CT (US); James B. Moore, Avon, IN (US)

Correspondence Address: WALL MARJAMA & BILINSKI, 101 SOUTH SALINA STREET, SUITE 400, SYRACUSE, NY, 13202, US

(73) Assignee: Carrier Corporation, Farmington, CT (US)

(21) Appl. No.: 11/054,654

(22) Filed: Feb. 9, 2005

Related U.S. Application Data
(60) Provisional application No. 60/640,276, filed on Dec. 30, 2004.

(51) Int. Cl. G06F 7/00

(52) U.S. Cl. 700/227

(57) ABSTRACT

A system allows a consumer to remotely access the status and settings of multiple home comfort systems via the Internet. The system comprises, a web server connected to the Internet. The web server is programmed to access the multiple home comfort systems and has a data storage device, a connection to the Internet to communicate with the consumer, and a messaging gateway coupled to a network to communicate with the multiple home comfort systems. At least one remote access module is connected to multiple home comfort systems. The remote access module communications with the web server via the network, and the messaging gateway. A consumer Internet device is connected to the Internet to allow the consumer to communicate with the web server, wherein the consumer can remotely access and control the multiple home comfort systems via the web server.

### CROSS REFERENCE TO RELATED APPLICATIONS

This application claims the benefit of U.S. Provisional Application Ser. No. 60/640,276, “Remote Access Control And Notifications Of Multiple Home Comfort Systems”, filed Dec. 30, 2004. The 60/640,276 provisional application is incorporated by reference herein.

### FIELD OF THE INVENTION

This invention relates to a system and method for remotely accessing comfort systems and more particularly to remotely access multiple comfort systems in multiple locations to obtain remote status reports, access and change settings.

### BACKGROUND OF THE INVENTION

A consumer can own residences at multiple locations. At each location, the consumer can further own multiple heating, ventilation and air conditioning (“HVAC”) systems. These home comfort (HVAC) systems can comprise furnaces, air conditioners, heat pumps, air filters, ventilators, air cleaners, and humidification control equipment. Many home comfort systems can be expanded further by using dampers to selectively channel air flow into several controllable zones within a home.

The home owner is typically required to be physically present at a comfort system control to view the status, including the current environmental readings and settings and/or to optionally change the settings. For example, a home consumer might view and then change the temperature setting of a thermostat that controls a particular zone within a home.

More recently, a thermostat has been offered that allows remote access to one or more zones of a single home comfort system where the consumer can directly dial into a module hardwired to an individual comfort system. Rudimentary commands and system parameters reside within the system hardware.

In another approach to remote comfort system access, Carrier Corporation offers a product called “ComfortChoice” that allows a consumer or commercial user to log in to a website to view and change the settings of a single thermostat at a single location.

The problem is that existing home comfort remote access systems can only access a single system at a single location. Moreover, each single system access requires a separate login event. But, increasingly consumers have a need to access and control multiple comfort systems at multiple locations.

Accordingly there is a need for a remote access, control and notification system that would allow a consumer to access multiple home comfort systems via the Internet with a simple login.

### SUMMARY OF THE INVENTION

The inventive system allows a consumer to remotely access the status and settings of multiple home comfort systems via the Internet. The system comprises, a web server connected to the Internet. The web server is programmed to access the multiple home comfort systems and has a data storage device, a connection to the Internet to communicate with the consumer, and a messaging gateway coupled to a network to communicate with the multiple home comfort systems. At least one remote access module is connected to multiple home comfort systems. The remote access module has a digital interface coupled to the multiple home comfort systems and a communications module to communicate with the web server via the network, and the messaging gateway. A consumer Internet device is connected to the Internet to allow the consumer to communicate with the web server, wherein the consumer can remotely access and control the multiple home comfort systems via the web server.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 shows a system to remotely access multiple comfort systems;

FIG. 2 is a flow chart showing the registration process;

FIG. 3 is a flow chart showing the steps used for remote web access;

FIG. 4 is a flow chart showing the steps used for remote telephone access;

FIG. 5 shows remote web access of a comfort system in example 1;

FIG. 6 shows a web browser page used for login in example 1;

FIG. 7 shows a web browser page used for viewing status and changing settings in example 1;

FIG. 8 shows remote telephone access of a comfort system in example 2;

FIG. 9 shows the notification system in example 3;

FIG. 10 shows an exemplary notification grid;

FIG. 11 shows an exemplary notification web browser screen; and

FIG. 12 is a flow chart showing the steps used for notification.

It is to be understood that the drawings are for the purpose of illustrating the concepts of the invention and are not necessarily drawn to scale.

### DESCRIPTION

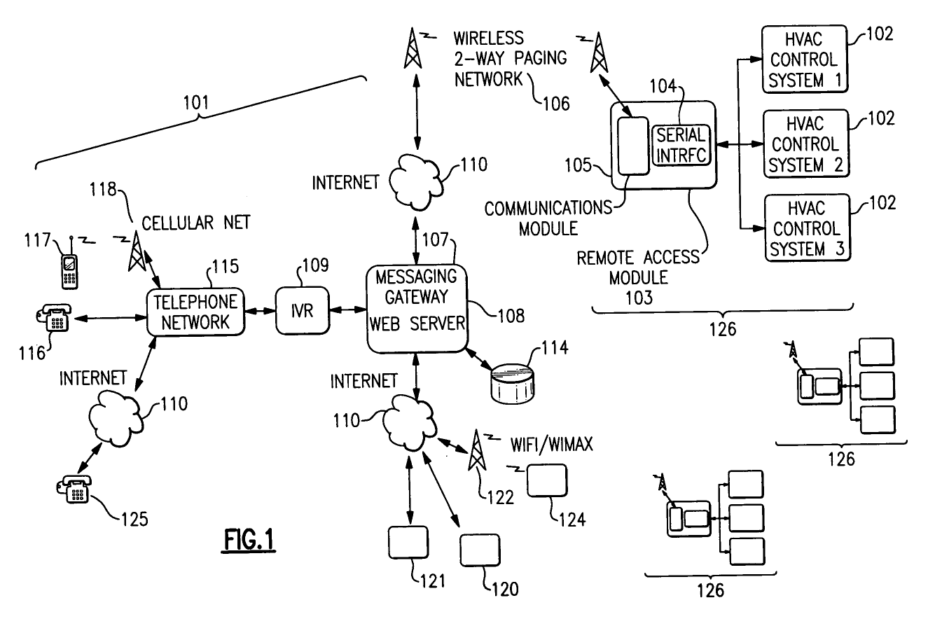

FIG. 1 shows a remote access and control system enabling a consumer to remotely access multiple comfort systems 126 at one or more locations. Access system 101 provides the consumer with one or more ways to connect to and to communicate with web server 108 running a computer program to send commands to and receive information from multiple comfort systems 126 through a remote access module 103. Each remote access module 103 can control one or more HVAC control systems (comfort systems) 102 at each location.

The consumer can register, setup notifications, and or access and control at least one comfort system via access system 101. Consumer specific login and configuration information, including comfort system locations, comfort systems at each location and detailed instruction information about each system, including optional notifications, can be stored as consumer data. The consumer data can be stored on Web Server 108, typically via data storage element 114 as a consumer profile. The consumer profile can be stored in a variety of data structures such as in one or more relational databases stored on data storage element 114, or some other compatible computer storage media accessible by web server 108. Once registered, a consumer can remotely access multiple comfort systems 126 in multiple locations by connecting to web server 108. The consumer can connect to web server 108 by one of several different connect methods, such as via the Internet or through a telephone system.

Connection to web server 108 through the Internet 110 can be accomplished in several ways. A consumer can connect to web server 108 using a personal computer (“PC”) 121, including an IBM compatible machine, such as those using an INTEL, AMD, or similar processor as well as by computers running another operating system (“OS”), such as an APPLE compatible OS. Other less featured terminals 120 with Internet connectivity can be suitable as well. Any suitable PC or terminal can also connect to the internet by a wireless network such as an IEEE 802.11 type WiFi or 802.15/16 WiMax connection 122 or a hardwired local area connection (“LAN”). Other suitable connections can be made by the consumer using an internet enabled cell phone 117 with web browser connecting to the Internet through a cellular network 118 or a PDA 119 with cellular, wireless, or wired access to the Internet.

A consumer can also connect to web server 108 from the telephone network 115. The consumer can use a cell phone 117 to connect to telephone network 115 via wireless cellular connection 118. Or, the consumer can use a traditional wired telephone 116 hardwired to telephone network 115. When connecting by telephone, the consumer can use the touch tone pad on the telephone to interact with a plurality of menus and menu options. The consumer telephone connection can be accomplished by Integrated Voice Response (“IVR”) system 109. IVR 109 can include a text to speech capability for interacting with the consumer including consumer login access codes and or passwords and for accessing web server 108. IVR 109 can also include touch tone recognition and or speech to text (speech recognition) for receiving consumer replies to menu prompts.

Web server 108 can communicate with a plurality of multiple comfort systems 126 at one or more locations via messaging gateway 107. Messaging gateway 107 can communicate with wireless system 106 via the internet or by a direct connection such as by Ethernet (not shown). Wireless system 106 can then connect with a communications module 105 associated with a particular multiple comfort system 126. Communications module 105 can be a two way paging module that is part of remote access module 103 used a location to communicate with one or more comfort systems 102 at each location. In one embodiment, wireless system 106 can be the SkyTel paging network. While wireless network 106 is shown as a 2-way paging network in FIG. 1, it should be noted that in other embodiments, wireless system 106 can be an Ethernet connection, 802.11 WiFi or 802.15/16 WiMax connection, or other suitable similar type wireless connection. In these aforementioned connections, communications module 105 can be selected from a group of communications modules capable of one or more of these connection modes.

Once connected via communications module 105, remote access module 103 communicates with one or more comfort systems 102 via digital interface 104. As shown in FIG. 1, digital interface 104 is typically a serial interface such as RS-485. Comfort systems 102 can be any type of heating ventilation and control (“HVAC”) system 102 capable of communicating with remote access module 103. Exemplary system components suitable for integration into a multiple home comfort system 126 by system controls 102 include thermostats, furnaces, air conditioning (“A/C”) units, zone controllers, heat pumps, humidity controls, and air cleaners.

Consumer operation of the access and control system of FIG. 1 will now be explained in further detail in the following sections, including registration, interaction via the Web, interaction via telephone, and notifications. Following the more detailed sections on operations, three examples describe advantageous embodiments.

Registration: Before using system 101, a consumer typically registers for the remote access service. A consumer inputs information into the system during registration to build a consumer profile. The consumer profile can include a username, access code, location information, system information, and information on the various HVAC zones in each system, such as the “kitchen zone” of a home comfort system. Where notifications are used, the profile can further include notifications tables. Notification tables are described further in the notifications section.

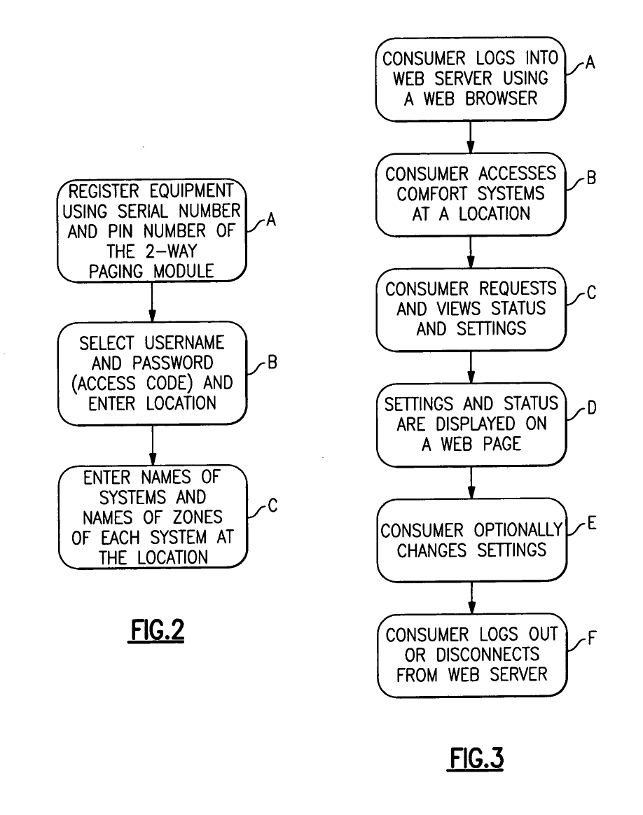

The registration process is explained for an exemplary multiple comfort system 126 where communications module 105 is a two way paging module having a serial number and a PIN number. The registration process is shown as a flowchart in FIG. 2. In step A, the consumer's equipment is entered using the serial number and PIN number pre-assigned to the two paging module 105. In step B, the consumer then selects a username and password (access code) and a description of a location (e.g. vacation home). In step C, at least one system is entered (e.g. main system) along with the zones in that system. The zones names can reflect actual rooms or portions of the residence controlled by a zone, e.g. upstairs or family room. Step C can be repeated to enter multiple systems at each location. Typically one two way paging module can serve an entire location, however, where there is more than one two way paging module at a common location, the entire process comprising steps A-C can be repeated for each two way paging module present. The consumer can add additional locations, systems, or zones as needed.

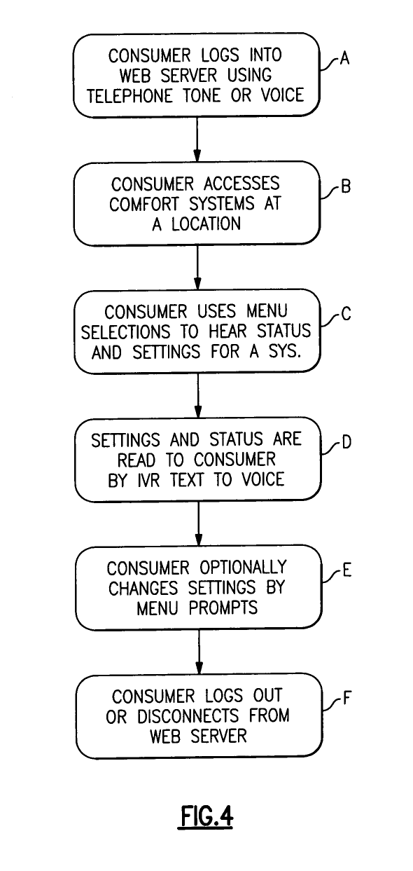

Interaction via the Web: Once registered, the consumer can login from any web browser, anywhere there is access to the World Wide Web (“web”), typically through the Internet 110. FIG. 3 shows the steps used where the consumer is accessing the system via the internet. In step A, the consumer does a login to web server 108. On successful login to web server 108, in step B, the consumer gains access to the comfort systems at a remote location. In step C, the consumer can request the current status and settings for any comfort system at the remote location. The status and settings are then returned for the equipment at that location and those settings are displayed on one or more web pages for consumer viewing in step D. In step E, the consumer can optionally adjust the settings. In step F, the consumer logs out or otherwise disconnects from web server 108.

Turning back to FIG. 1, the process steps of FIG. 3 are now described in more detail in terms of communications across the system 101 components. The consumer logs into the web server by communicating with one of the optional devices 117, 119, 120, 121, and or 122. For this discussion, the connection is made via a PC 121 connected to the Internet 110 by a standard connection, such as DSL, cable modem, phone modem, T1 line, etc. A connection to the web server 108 URL is made using a standard web browser such as Internet Explorer, Mozilla Firefox, or equivalent browser. On login and request for current settings, web server 108 connects with the remote access module associated with the login username and password as follows: Web server 108 accesses the customer's data, typically from data storage area 114. Web server 108 then connects to the appropriate remote access module 103 as defined by its serial number and PIN number via messaging gateway 107, across wireless paging network 106, to a two way paging module 105 in the addressed remote access module 103. A request for current status command is sent across an RS-485 serial connection to the comfort controls 102 at that location. The status report is returned by one or more controls 102 through the serial link back to remote access module 103. The replies can be formatted into a reply message by remote access module 103 and returned to web server 108 via two way paging module 105, wireless paging network 106 and messaging gateway 107. The received reply message is received and appropriately parsed to display the returned information on a web page representing data returned from one or more comfort controls 102 at that location.

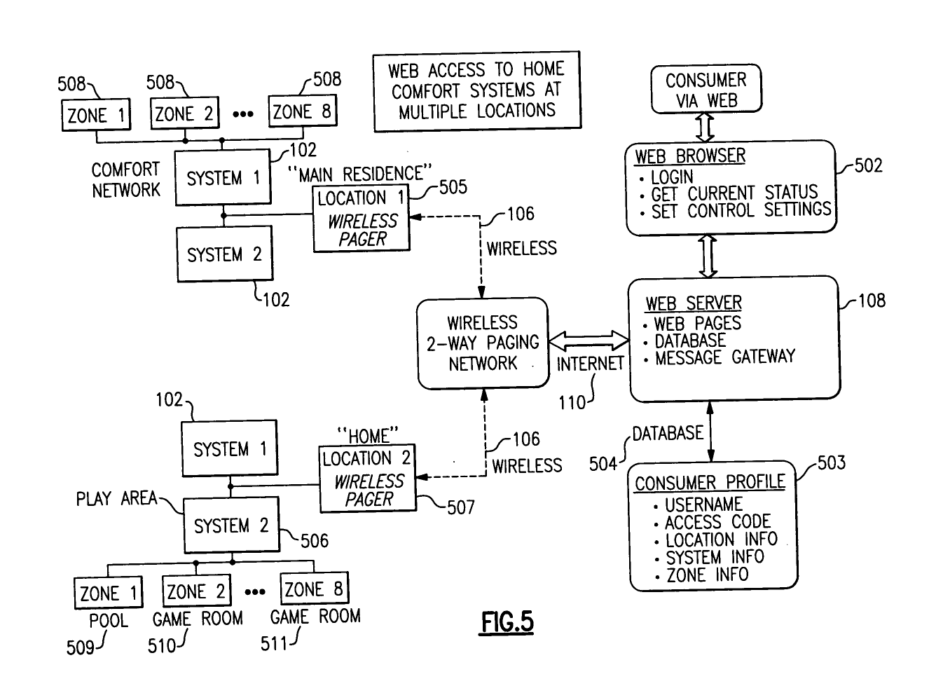

Interaction via Telephone: Alternatively, as shown in FIG. 4, the consumer can login by telephone (step A). In step B, the consumer can interact through the Integrated Voice Response (“IVR”) system 109 to gain access to web server 108 via voice menus and touch tone responses. Following a successful login to web server 108, in step B, in step C, the consumer can gain access to various comfort system menus via IVR 109 voice prompts, to hear the status and settings for a system at a remote location. The status and settings for the selected system are then read to the consumer by the IVR 109 text to voice function in step D. In step E, the consumer can optionally adjust the settings via voice menu prompts. In step F, the consumer logs out or otherwise disconnects from web server 108, as by hanging up the telephone.

Referring back to FIG. 1, the process steps of FIG. 4 are now described in more detail in terms of communications across the system 101 components. The process of telephone access is very similar to web access, except that consumer communications is done through a telephone. The consumer (having pre-registered from a web access point) calls a telephone number, which can desirably be a toll free number, to gain access to web server 108. Web server 108, communicating with the consumer via IVR 109 text to speech, presents a login menu to the consumer. The consumer can press standard touch tone telephone keys to answer all prompts, including this initial prompt for a login password. The login password is typically a numeric code, but can be alpha numeric using standard touch tone keypad mapping to alphabetic characters. Once logged in to a particular location, the web server, via IVR 109 presents the user with further menu options allowing access to one or more status reports from one or more comfort controls 102 at that location. The query and reply through system components 101 is otherwise the same as previously described for web browser internet access with the exception that the web pages available to an Internet web browser connection are replaced by the text to voice menu offerings and status reply messages are converted to speech by IVR 109 for a regular telephone call with the consumer. It should be noted that the consumer's replies to IVR 109 by touch tone signals can be replaced by voice commands where IVR 109 additionally or alternatively comprises speech recognition capability.

Notifications: It can be desirable for comfort systems to notify concerned or responsible parties of system status, system events, alarms, trips, and various other failures. These notifications can be routine, as in a periodic status update of readings and settings. A routine notification is typically something that does not require immediate attention or action such as a notification that it is time to change a filter or replace a humidifier pad. Or, a notification can be urgent. An urgent notification generally requires immediate attention. For example, a low temperature notification can be caused by a system malfunction that could lead to damage to a consumer's residence due to frozen pipes from lack of heat. Other exemplary urgent notifications include a fan motor malfunction, a control or thermostat malfunction, and a high temperature notification. Notifications can pertain to any system component in a comfort system, including thermostats, furnaces, A/C units, zone controllers, heat pumps, humidity controls, humidifiers, and air cleaners.

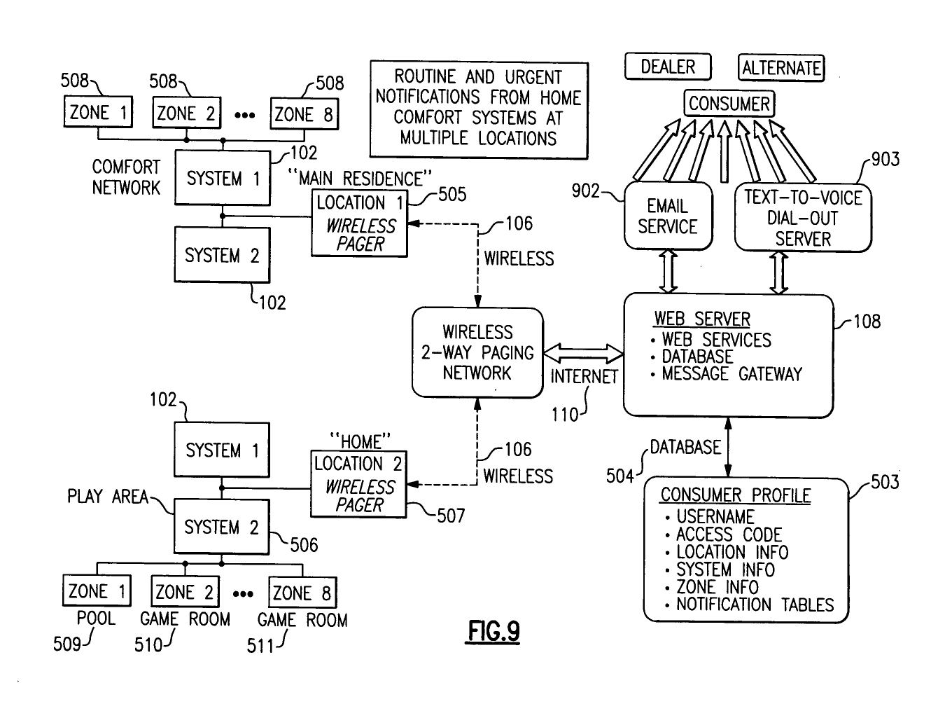

Turning to FIG. 1, remote access module 103 constantly monitors the state of the consumer's comfort system. A routine or urgent notification can be detected by remote access module 103. Remote access module 103 can send the notification to web server 108 using communications module 105, a 2-way paging module in one embodiment, communicating via communications network 106 to messaging gateway 107. Messaging gateway 107 sends the notification to web server 108. Web server 108 determines if the notification is routine or urgent and then can consult a notification table to determine which access methods should be invoked to deliver the notification to one or more designation recipients including, but not limited to, the consumer, one or more alternate contacts, and one or more servicing dealers. Web server 108 can use an email protocol to send a notification by an email service (902, FIG. 9) to a text pager 124 via a text pager network 123, or to directly send an email to an email address via a network such as the Internet 110. A text to voice dial out system, such as IVR 109 can be used to send a notification via telephone network 115 to telephone 116, cell pone 117 via cellular network 118, or by other phone connections such as over VOIP device 125 using the Internet 110. Typically IVR 109 can access the Internet 110 via telephone network 115, but it is also contemplated that an IVR 109 could dial a VOIP device via direct connection to the Internet 110.

A consumer can initially register their equipment with web server 108 using the previously described registration process. In addition to defining systems and zones at a location as previously described, the consumer can set up routine and urgent notifications associated with these systems. They can also designate recipients of the notifications, optionally including themselves, alternate contacts, servicing dealers, and other operational or maintenance related contacts via any combination of contacts and contact methods as previously described. It is further contemplated that notifications could be automatically constructed in one or more FAX formats as well.

Typically a routine notification can be sent once without acknowledgement by the consumer or other recipient. But, an urgent notification can be re-sent indefinitely until acknowledged. The consumer or service dealer can acknowledge an urgent notification by telephone, as by IVR 109, or by logging onto web server 108. In addition, once an urgent notification is detected, the comfort system can be queried through via web server 108 by web browser, as by PC 121 via the Internet 110, or by voice, as by cell phone 117 via IVR 109 (as a text to voice dial out server 903 in FIG. 9), to provide more detailed information on the type of fault or malfunction that is being reported. Thus a responding service dealer can advantageously ensure that they have the correct repair parts with them when they visit the location.

FIG. 12 summarizes the steps used for an exemplary notification. In step A, remote access module 103 detects a notification. In step B, remote access module 103 sends the notification to web server 108. In step C, web server 108 determines if the notification is routine or urgent. In step D, web server 108 consults the appropriate notification table. In step E, the web server invokes one or more notification methods to one or more notification recipients based on the notification table. In the case of an urgent notification, the notification can be indefinitely resent at some predetermined interval, until acknowledged by one or more recipients.

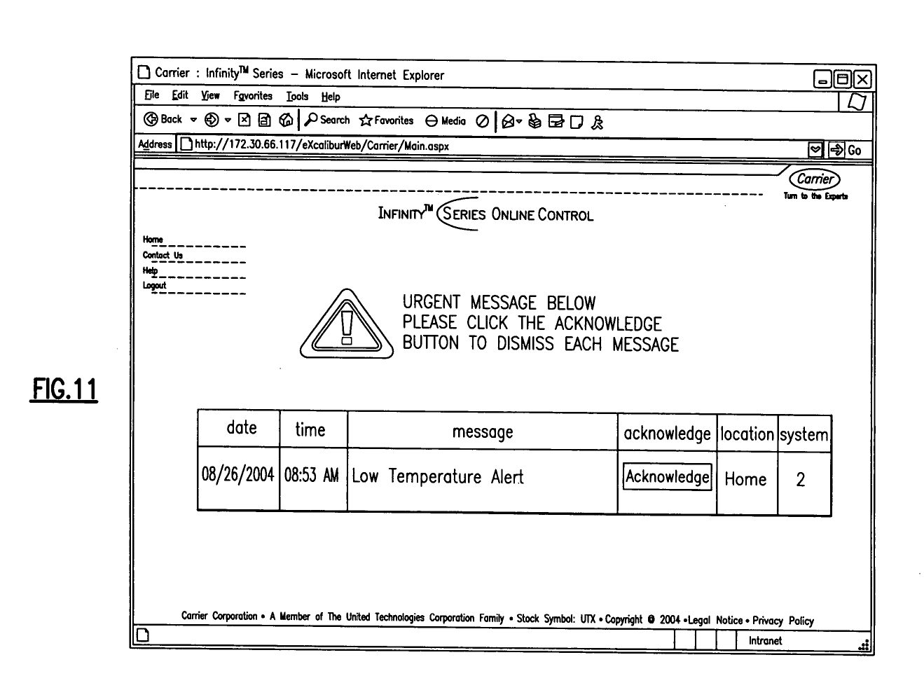

An advantageous embodiment of the notification system can comprise a grid of various methods of notification and how they handle routine and or urgent notifications. FIG. 10 shows an exemplary grid where the notification routes available include phones 1 & 2, a text pager, and an email address. Phones 1 and 2 are two separate telephone numbers. They can be standard landlines, cellular telephones, voice over Internet protocol (VOIP) telephony, or other devices capable of receiving phone calls. The text pager can be a standard text pocket pager as those offered by pager providers. Notification systems can similarly use other related devices, including PDAs and cellular phones capable of receiving text messages. And, email text notifications can be sent to any email address accessible by a network, typically via the Internet. It should be noted that many devices can function in one or more modes. For example, many cellular phones can receive voice calls to a telephone number, text messages sent by telephone or via a service provider, as well as offer web enabled services, such as receiving email messages association with one or more email accounts.

### EXAMPLES

The following three examples show specific embodiments. In each of these examples, communications module 105 is a two way paging module. Serial interface 104 is an RS-485 interface. And, systems 1 and 2 are advantageously Carrier Infinity or Bryant Evolution home comfort controls. It is also understood that a registration has been completed for at least one location, one system, and one zone in that system.

### Example 1

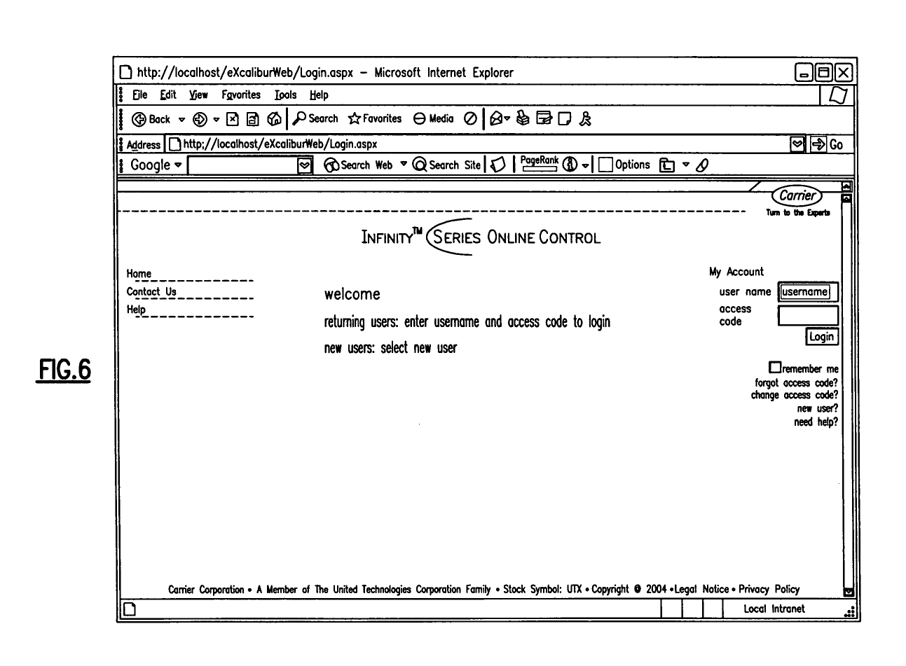

Example 1 is based on FIG. 5 showing an exemplary embodiment of a system 101 accessed by Internet connection. In this example, a consumer accesses location 2, a home. System 2 506 is designated as the “PlayArea”. Zone 1 509 is the “Pool Room”, Zone 2 510 is the “Game Room” 510, and Zone 8 511 is the “Sun Room”. The exemplary system shown in FIG. 5 is now compared to the system diagram of FIG. 1. The consumer's profile, including login, location, system, and zone information can be stored as consumer profile record 503 in database 504 on data storage element 114.

The consumer accesses the system via the web, using web browser 502. FIG. 6 shows a web browser page used in this example for consumer login according to step FIG. 3, step A. Web browser 502 can be running on any fixed, portable, or mobile computer or terminal platform capable of running a suitable browser such as PC 121 in FIG. 1. Web server 108 comprises the web pages to be displayed to the consumer, a database including consumer profile data that can be stored on data storage element 114, and message gateway serving the function of messaging gateway 107. In the exemplary system of FIG. 5, message gateway 107 communicates with Wireless 2-way paging network 106 via Internet 110.

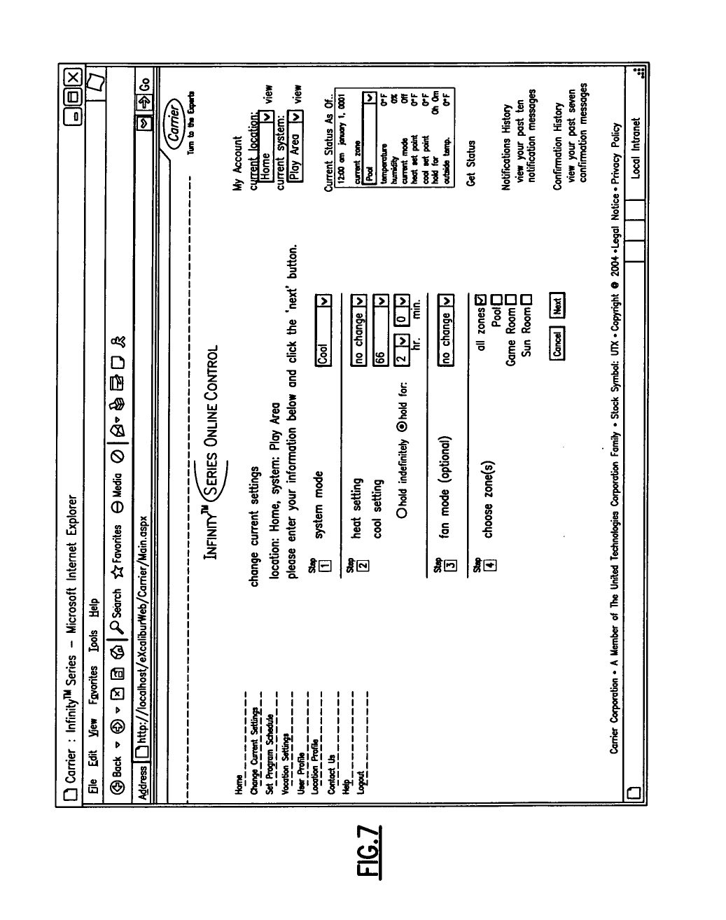

As shown in FIG. 7, the consumer can view the status of the “play area” system 506, and optionally change the temperature setting in several zones on the play area system, including game room 510. It can also be seen on this exemplary web page that the current status of the zones in this system (pool, game room, and sun room) can be viewed using the pull down menu on the right side of the page labeled “current status of”.

### Example 2

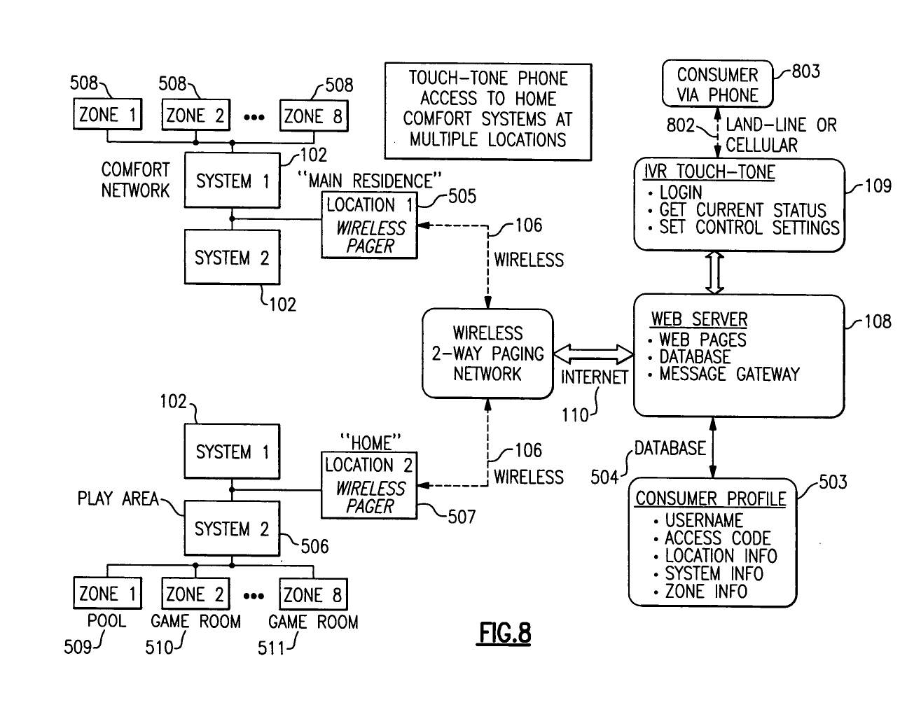

Example 2 is based on FIG. 8 showing an exemplary embodiment of a system 101 accessed by telephone through a telephone network 115 and IVR 109. In this example, a consumer accesses location 2, a home. System 2 506 is designated as the “PlayArea”. Zone 1 509 is the “Pool Room”, Zone 2 510 is the “Game Room” 510, and Zone 8 511 is the “Sun Room”. The exemplary system shown in FIG. 8 is now compared to the system diagram of FIG. 1. The consumer's profile, including login, location, system, and zone information can be stored as consumer profile record 503 in database 504 on data storage element 114.

The consumer accesses the system via a telephone instrument 803. Telephone instrument 803 can be a wired telephone 116, a cell phone 117, a VOIP based phone 125, or other telephone instrument capable of sending telephone touch tones and voice, and receiving voice, via telephone network 115.

After dialing a telephone number, advantageously a toll free number, IVR 109 presents a voice greeting such as “Welcome to touch-tone access for your comfort system”, followed by a voice prompt, “Please enter your access code, followed by the pound key”. The system then prompts for location, “Please select location. For Main Residence, press 1, for Home, press 2 (the two locations that are shown in example 2, FIG. 8). In the example, the consumer pressed telephone key “2” for location home. The system then prompts for system, “Please select system. For system 1, press 1, for system play area, press 2”. The consumer can press telephone key 2 to select the play area of FIG. 8. One option of the following menu presented to the consumer is “For location home, system play area, to get current status press 1”. The status of this selection can then be read to the consumer by the IVR 109 text to speech module. For example, the system can recite by voice, “The system is play area. The heating setpoint of the game room is 68 degrees”. Similar menu options can allow changes to the setpoint. For example, a change status menu can prompt, “The change the heating temperature, press 1”. A typical reply to a changed setpoint is “Thank you. Your changes are currently being processed. Your changes could take up to three minutes to be active”. A final menu option is “To end this call press *, or hang-up. This disconnects the consumer from web server 108. Other menu options beyond these examples and using this technique, allow for the entire range of web browser options and responses to be duplicated via telephone access.

It can thus be seen that any status reports or settings that can be viewed or changed by web access as in example 1, can also be accomplished by telephone access through a selection of voice prompt menus and replies by selection or setting conveyed by telephone touch tone responses. The exemplary system was constructed to react to touch tone replies, but it can also be seen that a similar system can react to telephone voice replies using a speech recognition algorithm or module in conjunction with IVR 109.

### Example 3

Example 3 is based on FIG. 9 showing an exemplary embodiment of a system 101 generating notifications by email service and/or by telephone through IVR 109. FIG. 9 shows a system for example 3, similar to the systems discussed with examples 2 and 3. In this example, there is a low temperature detected in the Pool zone which generates an urgent low temperature notification. A grid similar to that shown in FIG. 10 was set up to send urgent notifications as follows: an email and phone notification is made to the consumer and also sent as a phone notification to the dealer. The consumer's profile, including login, location, system, and zone information and the notification grid, can be stored as consumer profile record 503 in database 504 on data storage element 114.

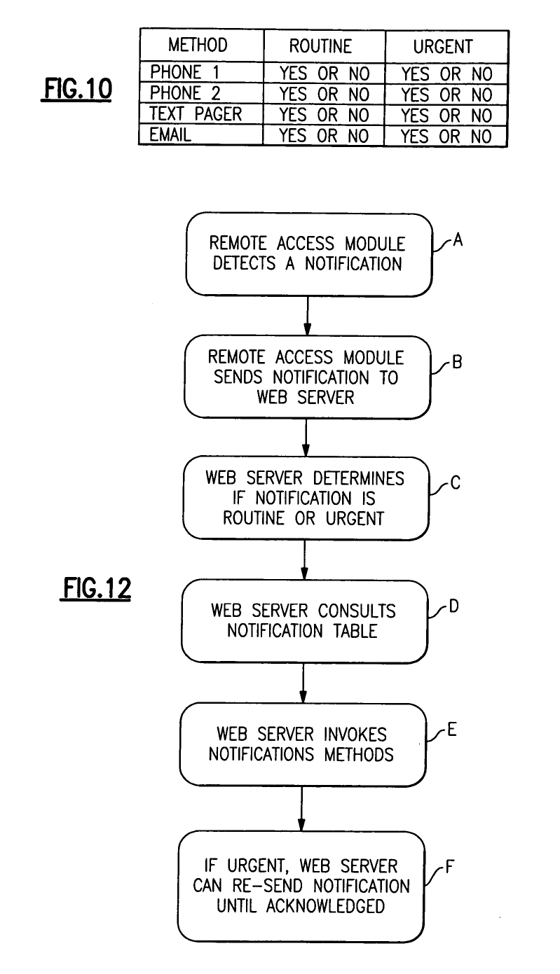

System 2 506 for the play area detects a low temperature in pool zone 1 509. System 2 506 generates an urgent low temperature notification sent by wireless pager from the home location 507 via wireless network and 2-way paging network 106 to web server 108 advantageously by Internet connection 110. Web server 108 automatically accesses the notification table for location 507 from the consumer profile record 503. Web server 108 correlates a low temperature alarm at pool zone 509 to an urgent notification for this system and sends an urgent email notification by email service 902 to consumer's stored email address and places an urgent notification phone call via text to voice dial out server 903 (as IVR 109 and telephone network 115) to both consumer's stored phone number and dealer's stored phone number. Consumer acknowledges the urgent notifications by logging into web server 108 by Internet 110 web browser access. Dealer answers the notification phone call by receiving the phone call and then acknowledges the call by responding by telephone through IVR 109 with touch tones to voice menu prompts. Dealer then dispatches a service person to home to diagnose the cause of the low temperature in pool zone 509 at home location 507. On logging onto the web server 108 using a web browser, consumer can view a notification screen as shown in FIG. 11.

It is understood that the above-described embodiments are illustrative of only a few of the many possible specific embodiments, which can represent applications of the invention. Numerous and varied other arrangements can be made by those skilled in the art without departing from the spirit and scope of the invention.

We claim:

1. A system to allow a consumer to remotely access the status and settings of multiple home comfort systems via the Internet comprising:
a web server connected to the Internet, the web server programmed to access the multiple home comfort systems, the web server having a data storage device, a connection to the Internet to communicate with the consumer, and a messaging gateway coupled to a network to communicate with the multiple home comfort systems;
at least one remote access module connected to multiple home comfort systems, the remote access module having a digital interface coupled to the multiple home comfort systems and a communications module to communicate with the web server via the network and the messaging gateway; and
a consumer Internet device connected to the Internet to allow the consumer to communicate with the web server, wherein the consumer can remotely access and control the multiple home comfort systems via the web server.

2. The remote access system of claim 1 wherein the home comfort systems are selected from the group consisting of furnace, air conditioner, heat pump, air filter, ventilator, air cleaner, and humidifier.

3. The remote access system of claim 1 wherein the digital interface is selected from the group consisting of a serial interface, wireless connection, WiFi connection, and an Ethernet connection.

4. The remote access system of claim 3 wherein the digital interface is an RS-485 serial interface.

5. The remote access system of claim 1 wherein the communications module is selected from the group consisting of a two-way paging module, Internet connection module, Wireless connection module, and WiFi connection module.

6. The remote access system of claim 5 wherein the communications module is a two-way paging module using a SkyTel two-way paging network.

7. The remote access system of claim 1 wherein the consumer Internet device is selected from the group consisting of a personal computer (PC), a notebook computer, laptop computer, hand-held computer, Internet capable PDA, and an Internet capable cell phone.

8. The remote access system of claim 7 wherein the consumer Internet device is connected to the Internet by a connection selected from the group consisting of wired local area network (“LAN”), WiFi, DSL, cable modem, and dial up Internet service.

9. The remote access system of claim 1 wherein at least one home comfort system comprises a Carrier Infinity or Bryant Evolution home comfort control.

10. The remote access system of claim 1 wherein the consumer Internet device runs a web browser for displaying status and settings of multiple home comfort systems from the web server.

11. The remote access system of claim 10 wherein the web browser is selected from the group consisting of Internet Explorer, Mozilla, Foxfire, and Netscape.

12. A method to allow a consumer to remotely access the status and settings of multiple home comfort systems via the Internet comprising the steps of:
logging into a web server from the Internet to send and receive information to the multiple home comfort systems;
accessing the multiple home comfort systems at a location;
requesting the status and setting of the comfort systems at the location; viewing the status and setting of the comfort systems at the location; and logging out from the web server.

13. The method of claim 12 further comprising the step of changing at least one setting of one of the comfort systems.

14. The method of claim 1 further comprising the step of registering to access the multiple home comfort systems at a location.

15. The method of claim 14 further comprising the steps of:
registering equipment in the multiple home comfort systems;
selecting a consumer access code; and
entering the name of a zone of a multiple home comfort system at a location.

16. The method of claim 15 wherein selecting a consumer access code comprises selecting a username and password.
